(19) United States
(12) Patent Application Publication
(10) Pub. No.: US 2006/0242934 A1
(43) Pub. Date: Nov. 2, 2006

(54) Air filter assembly

(75) Inventor: Tom Sharp, Jackson, TN (US)

Correspondence Address: GREER, BURNS & CRAIN, 300 S WACKER DR, 25TH FLOOR, CHICAGO, IL, 60606, US

(73) Assignee: Midwest Air Technologies, Inc.

(21) Appl. No.: 11/115,726

(22) Filed: Apr. 27, 2005

(51) Int. Cl. B01D 46/00

(52) U.S. Cl. 55/495; 55/498; 55/510

(57) ABSTRACT

An air filter assembly including an air filter housing having a base, a sidewall, and an upper end, being configured for receiving an air filter element, and an end cap configured for attachment to the upper end of the housing without the use of tools.

### BACKGROUND OF THE INVENTION

The present invention generally relates to air filter assemblies for use on devices such as air compressors, and more specifically, to air filter housing assemblies having replaceable filter elements.

Air filter assemblies are known in the art for receiving and enclosing air filters that are used in industrial applications such as air compressors, vacuum pumps, and the like. Current assemblies generally include an air filter element, a receptacle for receiving the air filter, a retaining ring and a cover for enclosing the air filter in the housing. In addition, the receptacle typically includes at least one opening in its end cap which is configured to introduce the fluid, either gaseous or liquid, that is to be filtered.

Current air filter housings generally include at least two pieces that are mechanically fastened together by staking, welding, orbital riveting, or locking with screw threads and a jam nut, or similar technologies which are known in the art. Generally, this two-piece construction consists of a cup-shaped receptacle and a nipple extending from a base of the receptacle. The process of manufacturing such multi-piece housings can be costly and time consuming. In addition to possible cost problems, the fastener used to attach the pieces can become loosened during operation of the compressor, which can eventually cause one of the pieces, such as the nipple, to become separated from the housing. This reduces the effectiveness of the assembly, and potentially causes malfunctions in, or damage to the compressor, for example through the admission of unwanted particulates.

Furthermore, if a piece of the housing, such as the nipple, were to break off during compressor operation, the entire air filter assembly typically requires removal from the compressor and replacement. Another potential problem is when one of the screws or fasteners used to hold the components of the housing together becomes loosened, and as a result, must be tightened. Solving these potential problems can be difficult tasks, because the assembly is generally difficult to access within the tight confines of the compressor. In some cases, special tools may be required. As a result, replacement of the assembly, the air filter, or the tightening of the housing components can be very time-consuming, thus reducing the efficiency of the compressor.

In addition, current air filter assembly end caps are not always resilient enough to withstand the shock caused during compressor operation. Current end caps are generally manufactured out of relatively hard plastic or sheet metal, which can become weakened and break due to shock forces generated during compressor operation, causing leaks that can contaminate the compressor. These plastic end caps can also become weakened as a result of the high operational compressor temperatures, again causing breakage or leakage. These problems can reduce both the efficiency and life of the assembly, because the filter elements or other components damaged by the fractured end cap may need to be replaced more often.

Finally, current plastic end caps can emit noise during compressor operation as it vibrates against the housing, which can be unpleasant for individuals present during operation.

Therefore, there exists a need for an improved air filter assembly in which the housing and its components will not break or become loosened during compressor operation. There also exists a need for an improved air filter assembly that is easily accessible and whose components are easily removable from the assembly housing without the use of tools. In addition, there exists a need for an improved air filter assembly end cap that is designed to withstand the shock and reduce the noise generated during compressor operation. Finally, there exists a need for an improved air filter assembly that is cost effective.

### BRIEF SUMMARY OF THE INVENTION

The above needs are met or exceeded by the present air filter assembly for use in an air compressor, featuring an end cap that is easily removable from the housing without the use of tools, so that the air filter can be easily replaced. In addition, the present air filter assembly end cap is manufactured out of a resilient material that can withstand the shock and reduce the noise generated during compressor operation. Finally, because of the resiliency and flexibility of the present air filter assembly end cap, it is easily accessible within the cramped confines of the compressor. The present assembly also features a unitary housing, thereby increasing the cost effectiveness of the assembly. Unlike current assemblies, whose components may need to be tightened because of the shock caused during compressor operation, the present unitary housing is intended to overcome this problem. Because the housing is unitary, maintaining the stable construction of the housing does not require the use of tools.

More specifically, the present air filter assembly includes an air filter housing having a base, a sidewall, and an upper end, being configured for receiving an air filter element; and an end cap configured for attachment to the upper end of the housing without the use of tools.

In another embodiment, the present air filter assembly includes an air filter element; an air filter housing configured for receiving the air filter element, the housing having a lip, a generally cylindrical sidewall extending from the lip, a base with a centrally located opening, and a nipple surrounding the opening; and an end cap having a top and a depending skirt.

In yet another embodiment, the present air filter assembly includes an air filter element; an air filter housing configured for receiving the air filter element, the housing having an upper end, a generally cylindrical sidewall extending from the upper end, a base with a centrally located opening, and a nipple surrounding the opening; and an end cap having a top and a depending skirt, the end cap being configured to encase the upper end of the housing.

### DESCRIPTION OF THE SEVERAL VIEWS OF THE DRAWINGS

FIG. 1 is an exploded perspective view of the present air filter assembly;

FIG. 2 is a vertical section of the air filter assembly of FIG. 1 as assembled; and

FIG. 3 is a fragmentary side view of the end cap of an alternate embodiment of the present air filter assembly, with portions shown in cross-section.

### DETAILED DESCRIPTION OF THE INVENTION

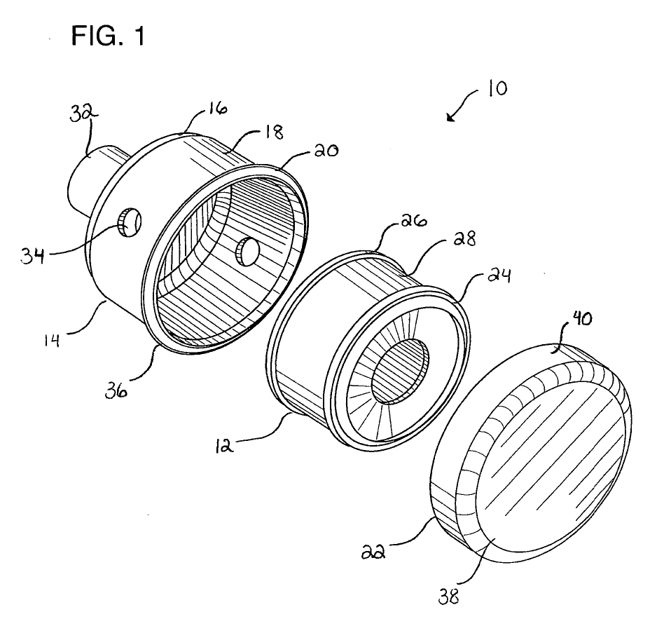

Referring to FIG. 1, an air filter assembly for use in a machine such as an air compressor (not shown) is generally designated 10. The assembly 10 includes an air filter element 12, an air filter housing 14 having a base 16, a sidewall 18, and an upper end 20, and an end cap 22 configured for attachment to the upper end of the housing without the use of tools.

The air filter housing 14 is configured for receiving the air filter element 12. As is known in the art, the air filter element 12 generally includes a top side 24, a bottom side 26, and a filter media 28 such as corrugated paper disposed between the top side and the bottom side. However, it is contemplated that the air filter element 12 can include additional components, as are known in the art.

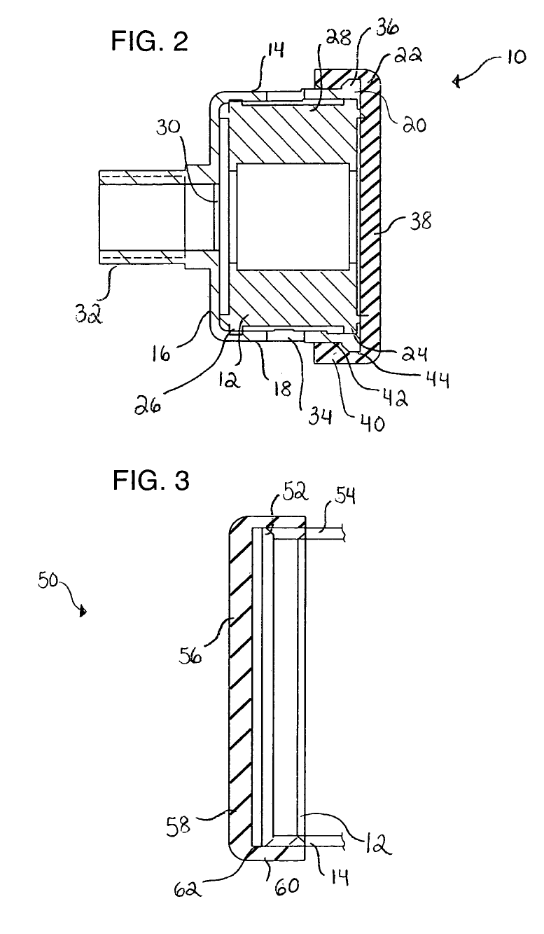

Referring next to FIG. 2, the base 16 of the air filter housing 14 defines a preferably generally centrally located opening 30. As seen in FIGS. 1 and 2, a generally tubular nipple 32 extends axially from the base 16 and is configured to surround the opening 30. It is contemplated that the nipple 32 is configured to secure the assembly 10 to a pipe or other inlet conduit located in or on the air compressor. It is further contemplated that by centrally locating the nipple 32 on the base 16, the assembly 10 will remain stable and balanced within the air compressor. It is also contemplated that the combined centrally located opening 30 and the nipple 32 are configured to allow the effluent of the filter element 12 to freely flow out of the filter element and to the inlet of the compressor. However, it is appreciated that other arrangements are possible, as are known in the art.

It is preferred that the housing 14 is a unitary piece that is integrally formed, preferably by means of aluminum die cast manufacturing, as is known in the art. However, it is appreciated that other conventional manufacturing technologies are available to produce unitary housings. It is contemplated that the unitary housing 14 is more cost-effective than current air filter housings that generally contain at least two pieces that are joined together by staking, welding, orbital riveting, or locking with screw threads and a jam nut, as are known in the art. It is further contemplated that the present unitary housing 14 with the integral nipple 32 can withstand more shock than current housings, where the nipple is a separate piece and can break off or become loosened during operation, possibly causing damage to the air compressor. As a result of the above-mentioned advantages of the present unitary housing 14, it is contemplated that the working life of the assembly 10 will be increased.

Referring again to FIG. 1, the sidewall 18 is preferably generally cylindrical, and is configured to conform with the shape of the air filter element 12, as is known in the art. Other shapes are possible depending on the configuration of the filter element 12. The sidewall 18 is configured to define at least one opening 34. It is contemplated that the at least one opening 34 is configured to introduce gaseous or liquid fluid into the housing 14 to be filtered by the air filter element 12, prior to introduction into the compressor in a known manner. In the preferred embodiment, two oppositely located openings 34 are included in the sidewall 18. It is contemplated that this arrangement allows the airflow into the housing 14 to be evenly distributed throughout the assembly 10 and into the air filter element 12. However, it is appreciated that other arrangements and quantities of the at least one opening 34 are available. It is further contemplated that the configuration of the at least one opening 34 on the sidewall 18 is advantageous over current air filter assemblies that include openings in the end cap, because it can prevent contaminants from entering the pump system of the air compressor.

Referring to FIGS. 1 and 2, the upper end 20 of the housing 14 preferably includes an optional, radially extending lip 36. It is contemplated that the lip 36 is configured for receiving the end cap 22, and is preferably annular but a discontinuous construction is alternately envisioned.

The end cap 22 includes a top 38 and a skirt 40 depending from the top in the direction of a longitudinal axis of the housing 14. As seen in FIG. 2, the depending skirt 40 has an interior wall 42 which includes an undercut or annular recess 44 that is configured to encase and surround the lip 36 of the housing 14. The end cap 22 and the lip 36 are configured to have a positive snap-fit relationship, wherein the lip fits securely into the undercut 44. As a result, it is contemplated that the end cap 22 will provide an airtight seal over the lip 36, and will securely retain the air filter element 12 within the housing 14. The undercut 44 is optional depending on the resiliency of the material used to form the end cap 22, as well as the construction of the wall 18.

It is further contemplated that, unlike conventional air filter assemblies, the present end cap 22 is relatively easily accessible within, and removable from, the compressor without the use of tools, due to the resiliency of the end cap and the snap-fit relationship between the lip 36 and the undercut 44 of the depending skirt 40. Although a snap-fit relationship is disclosed in the present assembly, it is appreciated that other known tool-free attachment structures are suitable.

The end cap 22 is preferably manufactured from a rubber or rubber-like resilient material, and it is appreciated that a variety of known resilient materials are suitable. It is preferred that the end cap 22 have a Durometer in the range of 55 to 90, with an optimal Durometer of 70. It is contemplated that in this range, the end cap 22 will have an optimal resiliency for withstanding the shock and vibrations generated during compressor operation. A feature of the present end cap 22 is that it is more resilient to shock and high temperatures than current end caps, which are generally manufactured from plastic and can crack or fracture when subjected to operational shock and vibration.

It is further contemplated that, unlike current plastic end caps, the present end cap 22 will reduce or dampen the noise produced during compressor operation. This is due to the resiliency of the end cap 22, which is softer than the plastic end caps of current assemblies, and as a result will not generate as much noise as it vibrates against the housing 14. Finally, it is contemplated that because of the resilient material used to make the end cap 22, it will be more accessible than current plastic end caps, which are more rigid and can become too hot to touch shortly after cessation of compressor operation.

In addition, because of the flexibility of the end cap 22, it is contemplated that the shape of the end cap 22 can be temporarily distorted to allow it to be snapped into or removed from the housing 14 in the tight confines of the air compressor.

Referring now to FIG. 3, another embodiment of the present air filter assembly is generally designated 50. Components shared with the assembly 10 are designated with identical reference numbers. The assembly 50 includes the air filter element 12, the air filter housing 14 configured for receiving the air filter element, and having an upper end 52, a generally cylindrical sidewall 54 extending from the upper end, the base 16 with the centrally located opening 30, and the nipple 32 surrounding the opening (not shown). An end cap 56 has a top 58 and a depending skirt 60. As is the case in the assembly 10, the end cap 56 is configured to frictionally encase the upper end 52 of the housing 14.

As seen in FIG. 3, the assembly 50 lacks a radially extending lip. Further, an interior wall 62 of the skirt 60 lacks an undercut as seen in the end cap 22. In this embodiment, it is contemplated that because of the resiliency of the end cap 56, it will encase and surround the upper end 52 of the housing 14, removably securing the air filter element 12 within the housing without the use of tools. It is further contemplated that the end cap 56, manufactured out of a rubber or rubber-like material having a Durometer value in the range of 55 to 90, is configured to be pushed onto the upper end 52, thereby securing it to the housing 14 by a friction fit. It is contemplated that because of the resiliency of the rubber end cap 56, a seal is formed between the end cap and the upper end 52, preventing air or fluid from escaping the air filter assembly 50. It is also contemplated that because of the resiliency of the end cap 56, it can be easily removed from the housing 14 without the use of tools by exerting a pulling action on the skirt 60 of the end cap, allowing the air filter element 12 to be easily replaced.

While a particular embodiment of the present air filter assembly has been described herein, it will be appreciated by those skilled in the art that changes and modifications may be made thereto without departing from the invention in its broader aspects and as set forth in the following claims.

1. An air filter assembly, comprising:
an air filter housing having a base, a sidewall, and an upper end, being configured for receiving an air filter element; and
an end cap configured for attachment to said upper end of said housing without the use of tools.

2. The assembly of claim 1 wherein said base defines a generally centrally located opening.

3. The assembly of claim 2 wherein a nipple extends from said base and is configured for surrounding said opening.

4. The assembly of claim 1 wherein said sidewall is generally cylindrical.

5. The assembly of claim 4 wherein said generally cylindrical sidewall defines at least one opening.

6. The assembly of claim 1 wherein said upper end of said housing includes a lip.

7. The assembly of claim 6 wherein said lip extends radially from said upper end of said housing.

8. The assembly of claim 1 wherein said air filter housing is a unitary piece that is integrally formed.

9. The assembly of claim 1 wherein said end cap includes a top and a skirt depending from said top.

10. The assembly of claim 1 wherein said end cap is configured to encase a lip of said air filter housing.

11. The assembly of claim 10 wherein said end cap has an annular recess that is configured for positively engaging said lip in a snap-fit engagement.

12. The assembly of claim 1 wherein said end cap is manufactured from a resilient material having a Durometer value in the range of 55 to 90.

13. An air filter assembly, comprising:
an air filter element;
an air filter housing configured for receiving said air filter element, said housing having a lip, a generally cylindrical sidewall extending from said lip, a base with a centrally located opening, and a nipple surrounding said opening; and
an end cap having a top and a depending skirt configured for frictionally engaging said lip.

14. The assembly of claim 13 wherein said generally cylindrical sidewall includes at least one opening.

15. The assembly of claim 13 wherein said end cap is configured to encase said lip of said housing.

16. The assembly of claim 13 wherein said depending skirt includes an interior wall, said interior wall having an annular recess configured for positively engaging said lip of said housing.

17. The assembly of claim 16 wherein said end cap is manufactured from a resilient material having a Durometer value in the range of 55 to 90.

18. The assembly of claim 13 wherein said housing is a unitary piece.

19. An air filter assembly comprising:
an air filter element;
an air filter housing configured for receiving said air filter element, the housing having an upper end, a generally cylindrical sidewall extending from said upper end, a base with a centrally located opening, and a nipple surrounding said opening; and
an end cap having a top and a depending skirt, wherein said end cap is configured to encase said upper end.

20. The assembly of claim 19, wherein said end cap is manufactured from a resilient material having a Durometer value in the range of 55 to 90.
